(19) United States
(12) Patent Application Publication
(10) Pub. No.: US 2023/0080572 A1
(43) Pub. Date: Mar. 16, 2023

(54) SYSTEM AND METHOD TO ENGINEER USER EXPERIENCE

(71) Applicant: CIGNITI Technologies Limited, Hyderabad (IN)

(72) Inventors: Rajesh Sarangapani, Hyderabad (IN); Jaya Raghuram Krovvidy, Hyderabad (IN); Naresh Pulugundla, Hyderabad (IN); Naga Sridevi Thorlikonda, Andhra Pradesh (IN)

(73) Assignee: CIGNITI Technologies Limited, Hyderabad (IN)

(21) Appl. No.: 17/958,287

(22) Filed: Sep. 30, 2022

Related U.S. Application Data
(60) Provisional application No. 63/203,828, filed on Aug. 1, 2021.

(51) Int. Cl. G06Q 10/06; G06Q 30/02; G06F 8/77

(52) U.S. Cl. CPC G06Q 10/06393; G06Q 30/0201; G06F 8/77

(57) ABSTRACT

The present invention provides system and method for quantifying the user experience which consider data from various stages in the product or a service lifecycle and derive the relevant key KPIs from the same which are then aggregated and calibrated accordingly. The main components of the present invention are UE factor selector (150), UE rating calibrator (180), UE variance classifier (160), UE emotion translator (190) and artefact generator (100). The present invention is used to evaluate the end user's experience thereby understand the type of emotion an end user might experience or express after using the service, application or the product.

### FIELD OF INVENTION

The present invention relates to the field of systems and methods for providing an enhanced user experience. More particularly, this invention relates to the fields of user experience, monitoring & analytics (system, user, application, user feedback) and quality assurance.

### BACKGROUND OF THE INVENTION

In general, most existing systems and methods provide a plurality of user experience modules through a plurality number of devices. Generally, users have several different preferences to obtain content and use content. Conventional and traditional methods use movements of a user as control inputs by sensing gross movement, such as a user movement, arm strike, arm swing and full body motion for an user control input. Current control systems and control user experience modules do not provide a sufficient means to automatically personalize a user experience based upon the movements or dexterous gestures.

There are several publications related to the specific system and prior arts disclosing methods for providing an enhanced user experience.

The patent application US2020005336A1 relates to systems and methods provided for providing a customized user experience. Providing a customized user experience may include receiving, from a graphical user interface displayed on a mobile device a user input indicative of a preferred level of interaction by the user, and monitoring, by a sensor, a facial expression of the user. Then, a first preference metric may be assigned to the user based on the monitored facial expression. Providing a customized user experience may further include monitoring, by a sensor, a behaviour of the user, assigning a second preference metric based on the monitored behaviour, and aggregating at least the user input, the first preference unit, and the second preference metric to generate a preference score of the user. The preference score may be stored in a central database, displayed on a remote device, and used to modify a customer service experience.

Another patent application JP2005044120A discusses methods to realize retrieval with dynamic information taken into consideration by relating the dynamic information such as a user's feelings in communicating with the other party to the information of the other party and storing the information.

Another patent U.S. Pat. No. 7,712,073B1 relates to a system and method for engineering data into interface control documents is provided. The method includes creating and loading an interface control document by selecting features of an interface control document to create, providing a standards document having interface control document standards, and providing a case tool for maintaining interface control documents. The method provides for generating the interface control document using the standards document and based upon the selected features, and storing the interface control document in the case tool. The method includes designating a document having data attributes for the interface control document, reading at least some of the data attributes from the document, loading at least some of the data attributes read from the document into the interface control document, and storing the interface control document having at least some of the data attributed in the case tool.

Similarly, the U.S. Pat. No. 8,516,435B2 for a method for generating implementation artefacts for contextually-aware business applications includes utilizing a platform independent model (PIM) of a business application; generating a platform specific model (PSM) from the PIM, wherein the generating of a PSM includes one or more transformations between one or more meta-models of the PIM and one or more meta-models of the generated PSM; generating implementation artefacts; and binding the generated implementation artefacts with any existing services of the business application.

Another patent U.S. Pat. No. 9,606,694B2 discloses several computerized tools, methodologies, and data structures, according to embodiments of the present invention. They are disclosed for collecting data for UX research and development directed to a product, process, and system and for developing personas and scenarios from the data for designing and for measuring the effectiveness of the product, process, and/or systems for use by the personas or real people. The tools, methodologies and data structures may be used individually or in sets.

Another patent application US20130339896A1 discloses a user interface and method. A user interface and method of using said interface that uniquely applies a web browser navigation style to engineering analysis applications is disclosed herein. The user interface, which may be implemented at least in part by use of a computer system, may comprise a browser panel, a tabbed workspace, a graphics view, a search box, and a search and select bar.

However, none of the existing systems and methods provides a better system or method to engineer a user experience. Also, the artefact generator, UE variance classifier, UE emotion translator, rating calibrator, UE factor selector are not disclosed completely as in our present application.

The current drawbacks which usually exist are that the treatment to user experience is always subjective and that there is poor productivity for a monitoring analyst in a system. Another major drawback is that you are unable to adopt a systematic approach of considering user, system, App, feedback, and the like in the market readiness evaluation.

Considering all the drawbacks and gap analysis in the existing technologies and systems, the present invention has a developed system that can quantify user experience across product or service lifecycle. Here the system specifically recognizes and addresses user emotion by individually processing and then aggregating different modes through a classification, rating, calibration, and aggregation framework. Also, a process or an approach to evaluate the market readiness for a product and service is established. Also, feedback to tune the quality of a service or product is established.

### OBJECTIVE OF THE INVENTION

The primary objective of the present invention is to develop a system for enhanced user experience quantification, advisory provisioning, and market readiness analysis.

Another objective of the present invention is to quantify the user experience based on the user emotion along with the operational inputs about a product, system, user and the like in the whole service or a product lifecycle spread across the pre, live and post experience phases.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing, the claims and the abstract as a whole.

In one aspect of the present invention, the system is used to evaluate the end user's experience there by understanding the type of emotion an end user might express post using the service, app or product.

In one aspect of the present invention, the system and the method will enable the service providers or the product owners to understand the readiness of their app or a service to go to market.

In another aspect of the present invention, the system and the method will enhance the ability of quality analysts to plan their test strategy better.

In another aspect of the present invention, the entire system and personnel can be benefitted with improved productivity by pinpointing issues, decision making and other matters.

### BRIEF DESCRIPTION OF THE DRAWINGS

The manner in which the present invention works is given a more particular description below, briefly summarized above, may be had by reference to the components, some of which is illustrated in the appended drawing It is to be noted; however, that the appended drawing illustrates only typical embodiments of this system and are therefore should not be considered limiting of its scope, for the system may admit to other equally effective embodiments.

Throughout the drawings, the same drawing reference numerals will be understood to refer to the same elements and features.

The features and advantages of the present system will become more apparent from the following detailed description a long with the accompanying figures, which forms a part of this application and in which:

FIG. 1: is a Block Diagram of the components and working of our system in accordance with our present invention and illustrates the UE factor selector in accordance with our present invention;

FIG. 2: illustrates the UE variance classifier in accordance with our present invention; and

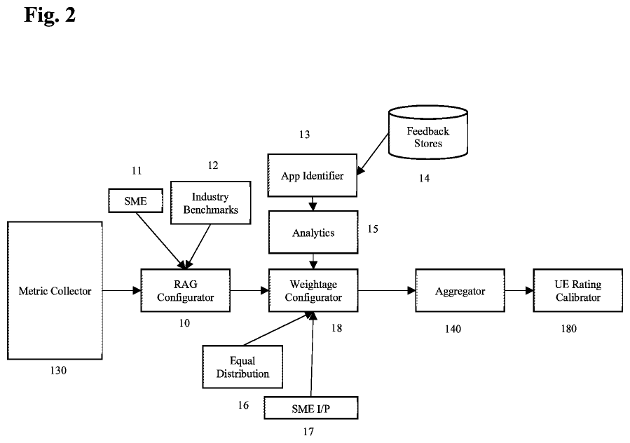

FIG. 3: illustrates the method of the UE emotion narrator, UE rating calibrator and artefact generator in accordance with our present invention.

### REFERENCE NUMERALS

The reference numbers are as follows:
100—Artefact Generator Tcs, Requirements (Product vs Technical)
100a—Prediction
100b—Prescribe
110—Analysis
145 110a—Pre-Exp Analysis
110b—Live-Exp Analysis
110c—Post-Exp Analysis
120—Connector
130—Metric Collector
130a Device Experience
130b Engagement
130c N/w Experience
130d App Experience
140—Aggregator
150—UE Factor Selector
150a—SME Input
150b—Feedback Store
160—UE Variance Classifier
160a—SME Input
160b—Rule Engine
170—Reactor
170a—User Action Performer
170b—Recommendation Engine
180—UE Rating Calibrator
180a—User Exp. Rating
180b—User Exp. Score
190—UE Emotion Translator
200—Emotion Narrator
200a—SME UP
200b—Feedback Store
10—RAG Configurator
11—SME UP
12—Industry Benchmarks
13—App Identifier
14—Feedback Stores
15—Analytics
16—Equal Distribution
17—SME UP
18—Weightage Configurator
19—SME UP
20—Industry Benchmarks
21—Analytics
22—SME UP
23—Rule Engine
300a—defect store
300b—SME input
301—iTriager
303—iResolver
302—iCoverager
304—iGenerator

### DETAILED DESCRIPTION OF THE INVENTION

The principles of operation, design configurations and evaluation values in these non-limiting examples can be varied and are merely cited to illustrate at least one embodiment of the invention, without limiting the scope thereof.

The embodiments disclosed herein can be expressed in different forms and should not be considered as limited to the listed embodiments in the disclosed invention. The various embodiments outlined in the subsequent sections are construed such that it provides a complete and a thorough understanding of the disclosed invention, by clearly describing the scope of the invention, for those skilled in the art.

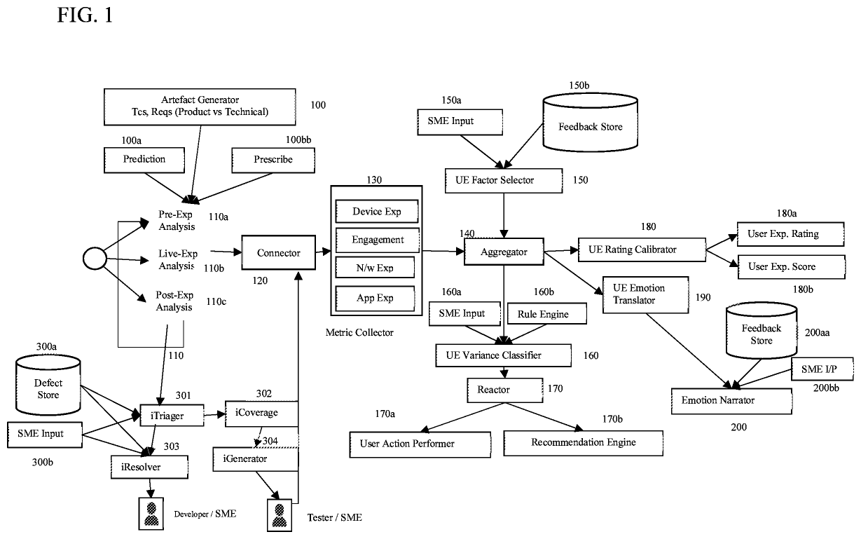

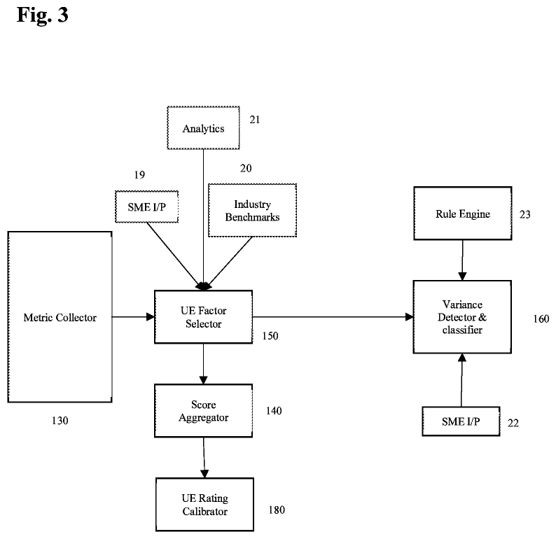

The present embodiment of our current invention with its components and working is illustrated in FIG. 1. to FIG. 3.

The present invention is used to evaluate the end user's experience there by understand the type of emotion an end user might express post using the service, app or a product. Also, it will help the service providers or the product owners to understand the readiness of their app or a service to go to market.

The present invention enables the quality analysts to plan their test strategy better. Using the present invention, monitoring analysts can get benefitted with improved productivity by pinpointing issues, decision making and matters based on user emotion.

Quantifying the user experience is a system or a method which consider data from various stages in the product or a service lifecycle and derive the relevant key KPIs from the same which are then aggregated and calibrated accordingly.

The present invention includes a UE factor selector module (150) which influences the aggregated UE score based on the weightages derived from various sources. Another UE rating calibrator module (180) provides means for overall user experience score and this is quantified based on the UE rating calibrator (180).

The present invention includes a UE variance classifier module (160) which enables to identify and filter the variance in the alerts provided which then fed into the reactor module.

The present invention includes a UE emotion translator (190) module which provides means to translate the overall calibrated score into an expected emotion of an end user.

The present invention includes an artefact generator module that analyses the data coming in and generate artefacts (100) which are functional, tech requirement, tests, test data, TE configurations and the like.

The overall process starts by connecting to the various data sources across the life cycle of a product or a service and collect various metrics based on the configured intervals. These metrics then moved to aggregator (140) where an aggregator will also collect data from the UE factor select (150) to identify the weightage requirements (18) to calibrate the scores.

The metric collector (130) sends data to the RAG configurator (10), which takes input from SME Input (11) and industry benchmarks (12). The RAG sends the configured data to the weightage configurator (18), which collects data from the feedback stores module (14) via the App identifier (13) and analytics (15), Equal distribution module (16) and the SME input module (17), which then sends the data to the aggregator (140) which feeds to the UE rating calibrator (180).

Once the aggregator (140) collects and aggregate the data from Metric collector (130) and UE Factor selector (150), it sends data into UE Score Calibrator (180) which will analyse the aggregators input along with the SME inputs if any to derive the overall UE Score and a predictable UE Rating and send back the UE rating score (180) to Aggregator (140).

The UE Factor selector (150) collects data from the metric collector (130), the industry benchmarks (20), SME input (19) and analytics (21). It then sends the data to both the score aggregator (140) and the Variance detector and classifier module (160) which receives data from the rule engine (23) and the SME input module (22).

Aggregator then sends the data to UE Emotion Translator (190) which will translate the emotion rating into the possible end user feedback attached with the emotion (200, 200a, 200b). Also, the same aggregator (140) sends the data to UE Variance classifier (160) which will analyse the metrics data along with the scores and ratings and apply the pre-defined or dynamic 260 rules to filter the various alerts and either alerts or reacts accordingly.

The Artefact generator (100) takes input from all the above modules and try to generate or provide inputs to help generate the test artefacts like functional and technical requirements, Test Scenarios and Test cases, Test Data applicable along with the Test Environment Configurations.

In one embodiment of our present invention, The iTriager (301) will take feed from the post experience data along with defect store (300a) and SME input (300b) to determine the validity of the defects identified; including known, duplicate defects.

In one embodiment of our present invention, If the defect is marked as valid by iTriager, iResolver (303) will pick up that and based on other feeds like historical defect data and SME input, it will build an advisory on who will be the right resource to resolve this and at what priority. Also, this will enable the developer to quickly identify the root cause and the possible fix for the issue.

In one embodiment of our present invention, if the defect is valid, iCoverager (302) will determine why the defect is leaked to production (If the test is available or not, and whether the same is executed or not).

In one embodiment of our present invention, if a test is not available, this module, the iGenerator (304) will help generate the test case, script and test data to execute the test cases against the fix delivered. Also, this will help identify the test suite to execute when the fix is ready.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A system for engineering user experience, comprising:
a. UE factor selector (150);
b. UE variance classifier (160);
c. UE emotion narrator (200);
d. UE rating calibrator (180) and
e. Artefact generator (100); are components of the system and
f. the method of system operation which comprises:
i. User experience rating and scoring;
ii. SME input and feedback storage;
iii. Prediction and prescription;
iv. User action performer and recommendation and
v. Emotion narrator and feedback storage;
Wherein, the data from various stages in the product or a service lifecycle are analysed and the relevant key KPIs from the same are derived which are then aggregated and calibrated accordingly.

2. The system for engineering user experience, as claimed in claim 1, wherein, the UE factor selector module (150) influences the aggregated UE score based on the weightages derived from various sources.

3. The system for engineering user experience, as claimed in claim 1, wherein, the aggregator (140)
a. collects and aggregates the data from Metric collector (130) and UE Factor selector (150)
b. it sends data into UE Score Calibrator (180), which will analyse the aggregator's input along with the SME inputs to derive the overall UE Score and a predictable UE Rating and send back the UE rating score (180) to Aggregator (140).
c. In turn, the Aggregator then sends the data to UE Emotion Translator (190) which will translate the emotion rating into the possible end user feedback attached with the emotion (200, 200a, 200b).
d. Also, the same aggregator (140) sends the data to UE Variance classifier (160) which will analyse the metrics data along with the scores and ratings and apply the pre-defined or dynamic rules to filter the various alerts and either alerts or reacts accordingly.

4. The system for engineering user experience, as claimed in claim 1, wherein, the UE variance classifier module (160) enables the system to identify and filter the variance in the alerts provided which are then fed into the reactor module.

5. The system for engineering user experience, as claimed in claim 1, wherein, the UE emotion translator (190) module provides the means to translate the overall calibrated score into an expected emotion of an end user.

6. The system for engineering user experience, as claimed in claim 1, wherein, the artefact generator module that analyses the data coming in and generate artefacts (100) which are functional, tech requirement, tests, test data, TE configurations and the like, wherein:
a. The iTriager (301) will take feed from the post experience data along with defect store (300a) and SME input (300b) to determine the validity of the defects identified; including known, duplicate defects.
b. If the defect is marked as valid by iTriager (301), iResolver (303) will pick that up and based on other feeds like historical defect data and SME input, it will build an advisory on who will be the right resource to resolve this issue and at what priority.
c. If the defect is valid, iCoverager (302) will determine why the defect is leaked to production.
d. If a test is not available, this module will help generate the test case, script and test data to execute the test cases against the fix delivered.
e. the iGenerator (304) will help generate the test case, script and test data to execute the test cases against the fix delivered and identifies the test suite to execute when the fix is ready.
